(19) United States
(12) Patent Application Publication
(10) Pub. No.: US 2012/0118113 A1
(43) Pub. Date: May 17, 2012

(54) RATCHET WRENCH

(76) Inventor: Chih-Hung WU, Taichung City (TW)

(21) Appl. No.: 13/049,352

(22) Filed: Mar. 16, 2011

(30) Foreign Application Priority Data
Nov. 16, 2010 (TW) 099222148

(51) Int. Cl. B25B 13/46

(52) U.S. Cl. 81/63.1

(57) ABSTRACT

A ratchet wrench includes a handle and a wrench head unit having head body rotatably mounted on a head portion of the handle, a plurality of tubular coupling member angularly displaced from each other, and a plurality of driving heads, each coupled with the respective tubular coupling member by means of a ratchet unit. By virtue of the ratchet unit, the driving head can be selectively turned in a clockwise direction, a counterclockwise direction, or both thereof. By virtue of the driving heads, the ratchet wrench can be used to turn a variety of fasteners.

### BACKGROUND OF THE INVENTION

1. Field of the Invention

This invention relates to a ratchet wrench, more particularly to a ratchet wrench with a plurality of driving heads to selectively operate a variety of fasteners.

2. Description of the Related Art

A conventional ratchet wrench generally includes a handle, a driving head mounted at an end of the handle, and a ratchet unit disposed therebetween. By virtue of the ratchet unit and sockets, the driving head can he adapted to rotate a fastener, such as a nut, a bolt, or the like. However, the ratchet wrench has limited application since only one driving head is provided. Moreover, the ratchet unit of the conventional ratchet wrench is generally disposed to permit a torque applied to the handle to be transmitted to rotate the driving head in a uni- or bi-rotational direction so as to rapidly tighten or loosen a fastener without removing the wrench from the fastener. However, due to the structure of the ratchet unit, the driving head can be operated only in a clockwise or counterclockwise direction when a uni-rotational direction is required. Thus, the conventional wrench suffers from the disadvantage that the user would have to remove the driving head from the fastener, reverse the handle, and re-engage the driving head with the fastener, which is inconvenient.

### SUMMARY OF THE INVENTION

An object of the present invention is to provide a ratchet wrench which has a plurality of driving heads for fasteners of different configurations and sizes, and can be selectively operated in clockwise, counterclockwise and bi-rotational directions.

According to this invention, the ratchet wrench includes a handle, a wrench head unit, a plurality of driving heads, and a plurality of actuating members. The wrench head unit has a head body mounted on and rotatable relative to a head portion of the handle, and a plurality of tubular coupling members which extend radially from the head body, and which are angularly displaced from each other. Each of the ratchet units has a ratchet wheel spacedly surrounded by an inner wall surface of the respective tubular coupling member, first and second toothed members which are disposed between the ratchet wheel and the inner wall surface, which have first and second outer surfaces slidably engaged with the inner wall surface, and which are configured to be displaceable among a bi-directional position, where the first and second toothed members are matingly engaged with the ratchet wheel to permit torque from the respective tubular coupling members to be transmitted to turn the ratchet wheel in both clockwise and counterclockwise directions, a clockwise position, where the first toothed member is matingly engaged with the ratchet wheel while the second toothed member is disengaged from the ratchet wheel so as to permit the torque to be transmitted only to turn the ratchet wheel in the clockwise direction, and a counterclockwise position, where the second toothed member is matingly engaged with the ratchet wheel while the first toothed member is disengaged from the ratchet wheel so as to permit the torque to be transmitted only to turn the ratchet wheel in the counterclockwise direction, and a biasing member which is disposed to bias the first and second toothed members toward the bi-directional position. Each of the driving heads extends axially from the ratchet wheel to be fittingly engaged in a tool socket. Each of the actuating members has first and second actuating portions which are disposed to selectively move the first and second toothed members away from the bi-directional position to a selected one or the clockwise and counterclockwise positions, and a manually operable portion disposed to be movable with the first and second actuating portions relative to the respective tubular coupling members.

### BRIEF DESCRIPTION OF THE DRAWINGS

Other features and advantages of the present invention will become apparent in the following detailed description of the preferred embodiment of the invention, with reference to the accompanying drawings, in which;

FIG. 1 is a perspective of the preferred embodiment of a ratchet wrench according to this invention;

FIG. 2 is a fragmentary exploded perspective view of the preferred embodiment;

FIG. 3 is an exploded perspective view of a wrench head unit, a ratchet unit, a releasing unit, a driving head, and an actuating member of the preferred embodiment;

FIG. 4 is a fragmentary side view of the preferred embodiment;

FIG. 5 is a sectional view taken along line V-V of FIG. 4;

FIG. 6 is a sectional view taken along line VI-VI FIG. 5;

FIG. 7 is a sectional view taken along line VII-VII of FIG. 6;

FIG. 8 is a sectional view similar FIG. 7, illustrating the ratchet unit displaced to a uni-directional state;

FIG. 9 is a sectional view similar to FIG. 5, illustrating an axial shaft displaced in an actuating position; and

FIG. 10 is a sectional view taken along line X-X of FIG. 9.

### DETAILED DESCRIPTION OF THE PREFERRED EMBODIMENT

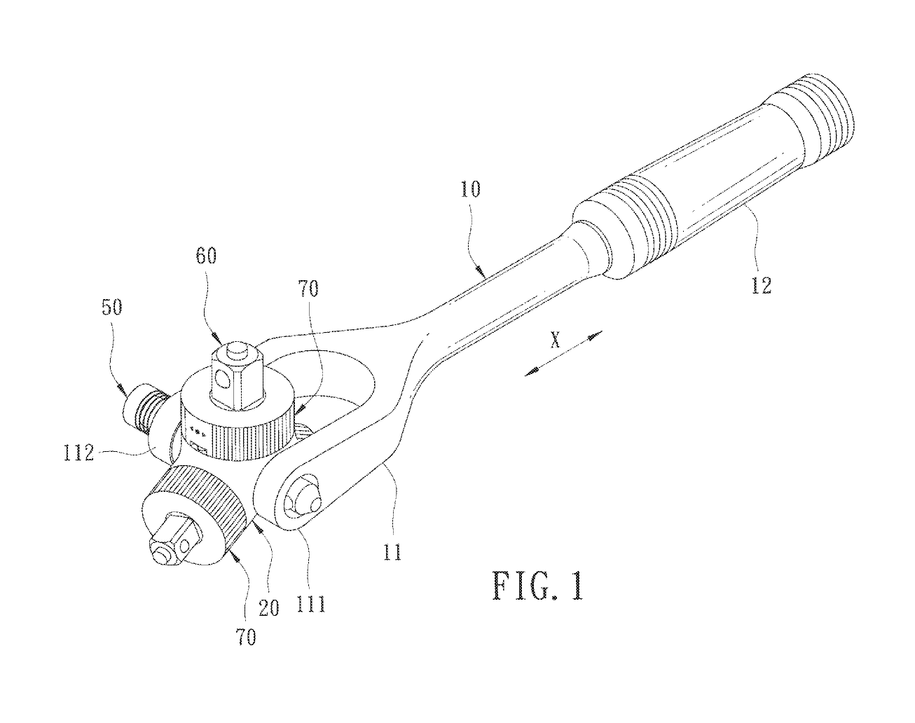

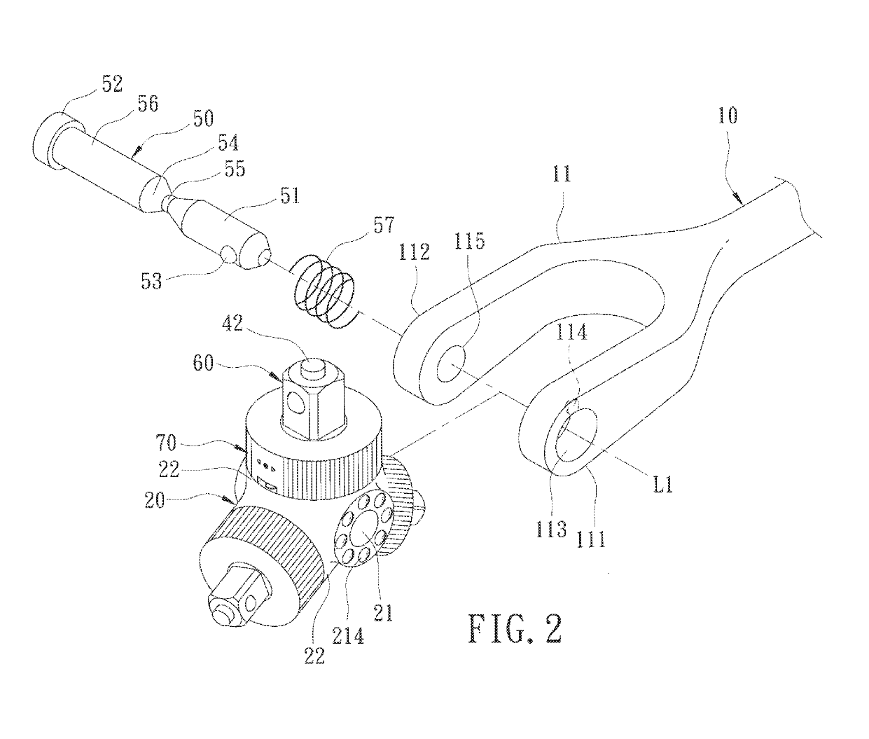

Referring to FIGS. 1 to 3, the preferred embodiment of a ratchet wrench according to the present invention is shown to comprise a handle 10, an axial shaft 50, a wrench head unit 20, a head positioning unit a plurality of ratchet units 30, a plurality of driving heads 60, a plurality of actuating members 70, a plurality of rim positioning units 80, and a releasing unit 40.

The handle has handgrip and head portions 12, 11 opposite to each other in a longitudinal direction (X). The head portion 11 includes first and second lugs 111, 112 spaced apart from each other to define a space, and respectively having first and second through holes 113, 115 which are aligned with each other to define a rotating axis (L1) that extends transverse to the longitudinal direction (X).

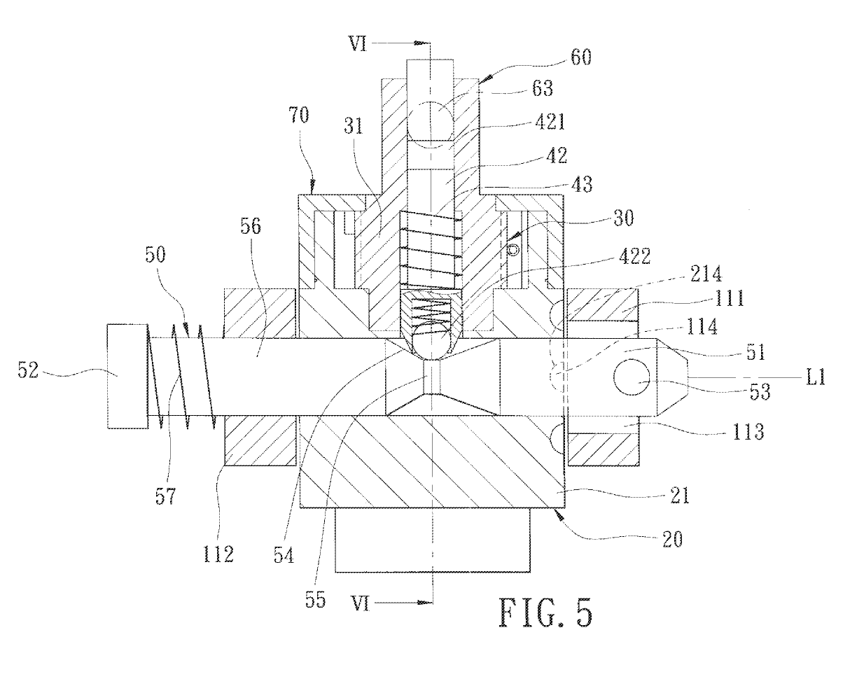

With reference to FIG. 5, the axial shaft 50 extends through the first and second through holes 113, 115 to be mounted on the head portion 11, and is movable along the rotating axis (L1) between non-actuating and actuating positions. The axial shaft 50 has a retaining portion 51 disposed to be retainingly engaged with the first lug 111 by means of a protrusion 53 that is frictionally engaged with an inner surface defining the first through hole 113, an operating portion 52 extending outwardly of the second lug 112 for manual operation, and a first camming region 54 disposed in the space and formed a smaller-diameter segment 55 and a larger-diameter segment 56. A shaft biasing member 57 is disposed between the operating portion 52 and the second lug 112 to bias the axial shaft 50 to the non-actuating position.

The wrench head unit 20 has a head body 21 which is disposed in the space, and which is rotatably supported on the axial shaft 50 about the rotating axis (L1), and a plurality of tubular coupling members 22 (three tubular coupling members 22 in this embodiment) which extend radially from the head body 21, and which are angularly displaced from each other about the rotating axis (L1) Each of the tubular coupling members 22 has an inner wall surface 221 which defines an accommodation space 222, and an outer wall surface 223 radially opposite to the inner wall surface 221. The inner wall surface 221 has forward and backward abutment regions 224 spaced apart from each other in a circumferential direction.

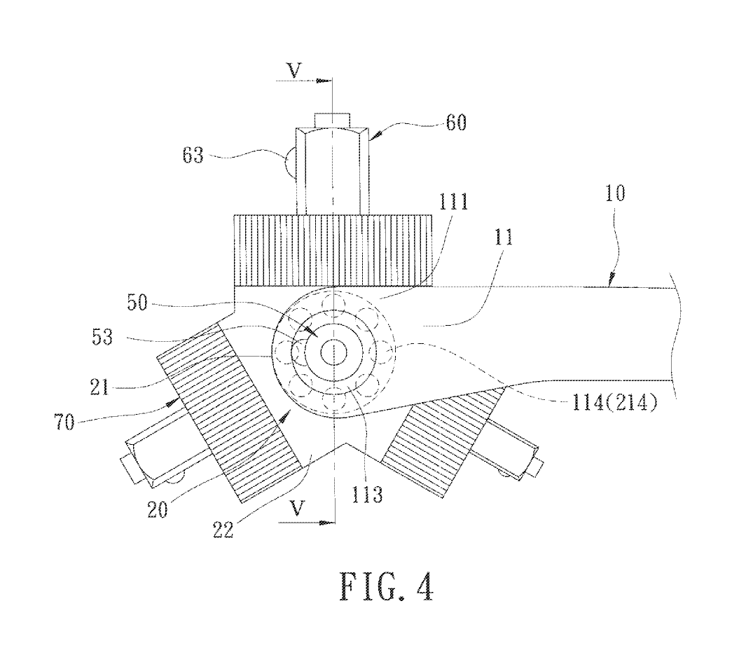

The head positioning unit includes a plurality of concavities 214 which are formed in the head body 21 and which are angularly spaced apart from one another about the rotating axis (L1), and a protrusion 114 which is disposed on the first lug 111 to be engaged with a click sound in a selected one of the concavities 214 so as to guard against rotation of the head body 21 about the rotating axis (L1) for ready use, as shown in FIG. 4.

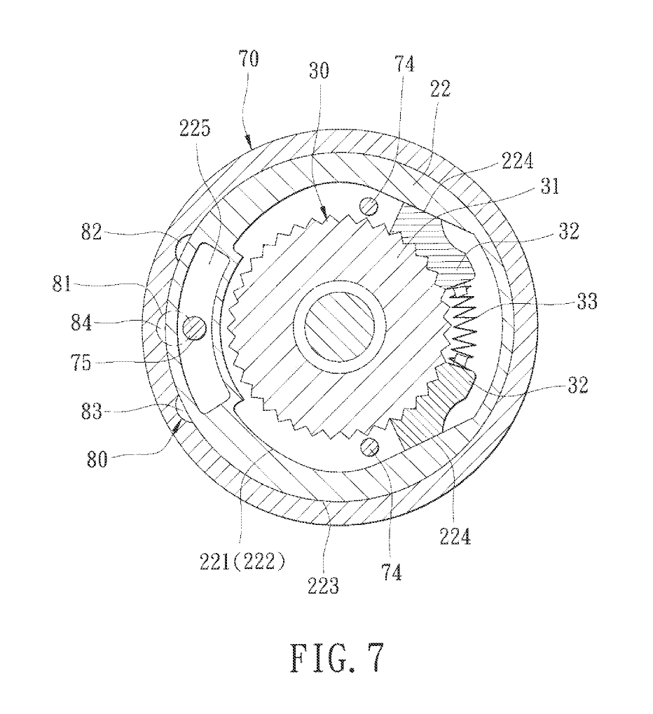

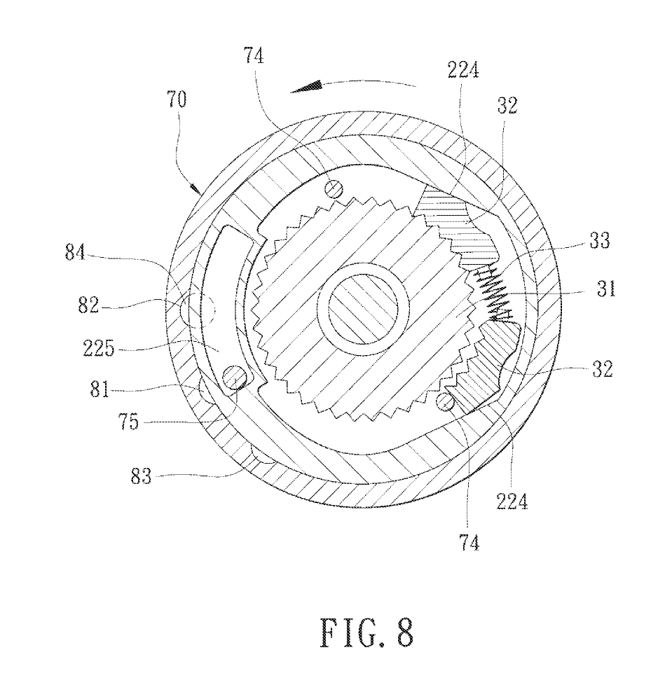

With reference to FIGS. 7 and 8, each of the ratchet units 30 has a ratchet wheel 31 which is rotatably mounted in the accommodation space 222 in the respective tubular coupling member 22 about a wheel axis (L2) radial to the rotating axis (L1) and which is spacedly surrounded by the inner wall surface 221, and first and second toothed members 32 which are disposed between the ratchet wheel 31 and the inner wall surface 221, and which have first and second outer surfaces slidably engaged with the forward and backward abutment regions 224 of the inner wall surface 221. The first and second toothed members 32 are configured to be displaceable among a bi-directional position, as shown in FIG. 7, where the first and second toothed members 32 are matingly engaged with the ratchet wheel 31 to permit torque from the respective tubular coupling member 22 to be transmitted to turn the ratchet wheel 31 in both clockwise and counterclockwise directions about the wheel axis (L2), a clockwise position, as shown in FIG. 8, where the first toothed member 32 is matingly engaged with the ratchet wheel 31 while the second toothed member 32 is disengaged from the ratchet wheel 31 so as to permit the torque to be transmitted only to turn the ratchet wheel 31 in the clockwise direction, and a counterclockwise position, where the second toothed member 32 is matingly engaged with the ratchet wheel 31 while the first toothed member 32 is disengaged from the ratchet wheel 31 so as to permit the torque to be transmitted only to turn the ratchet wheel 31 in the counterclockwise direction.

Each ratchet unit 30 further has a biasing member 33 which is disposed to bias the first and second toothed members 32 toward the bi-directional position.

It is noted that the forward and backward abutment regions 224 are configured such that, when the first and second toothed members 32 are selectively biased by the biasing member 33 to move from a corresponding one of the clockwise and counterclockwise positions (FIG. 8) to the bi-directional position (FIG. 7), a corresponding one of the forward and backward abutment regions 224 forces the corresponding one of the first and second toothed members 32 radially against the ratchet wheel 31 to ensure firmness of the mating engagement therebetween.

Each of the driving heads 60 extends along the wheel axis (L2) from and is integrally formed with the ratchet wheel 31 and outwardly of the accommodation space 222 to be fittingly engaged in a tool socket (not shown). The driving head 60 defines an internal chamber 61 which extends along the wheel axis (L2) and through the corresponding ratchet wheel 31, and has a through hole 62 extending radially to he communicated with the internal chamber 61. A ball 63 is received in the through hole 62 for retaining the tool socket fittingly engaging the driving head 60, and has an outer surface serving as a second cammed region.

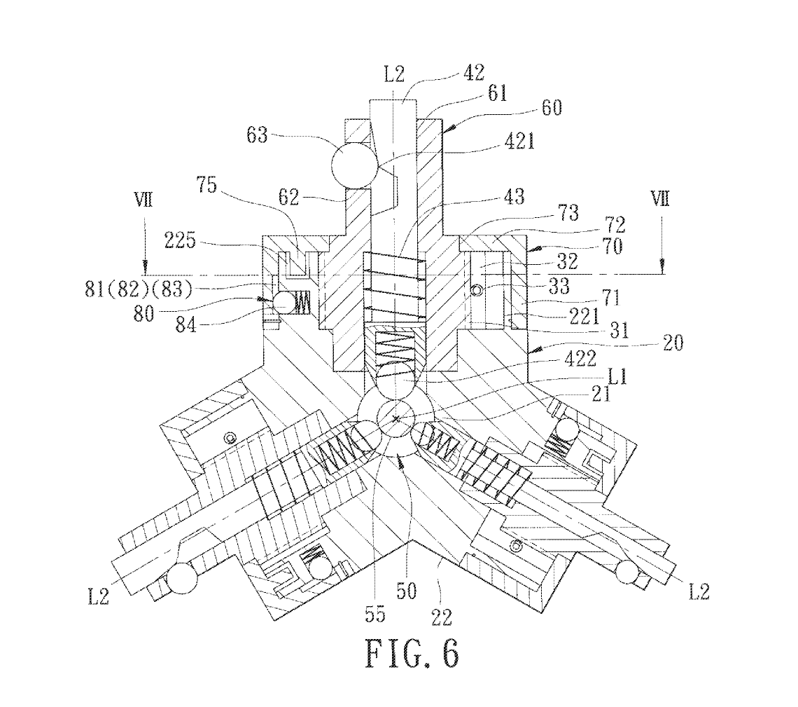

With reference to FIGS. 6 and 7, each of the actuating members 70 is in the form of a cap, and has a rim 71 which is disposed to surround, and be circumferentially movable relative to the outer wall surface 223 of the respective tubular coupling member 22 to serve as a manually operable portion 71, an end wall 72 having a through hole 73 for extension of the driving head 60, and first and second actuating portions 74 which extend from the end wall 72 into the accommodation space 222 and which are angularly spaced apart from each other to selectively move the first and second toothed members 32 away from the bi-directional position to a selected one of the clockwise and counterclockwise positions.

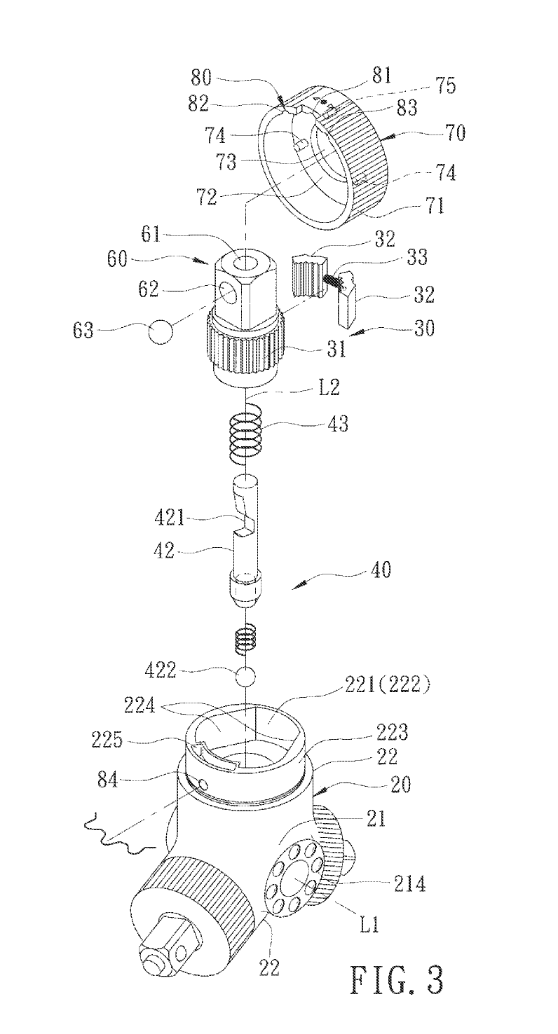

With reference to FIGS. 3 and 6 to 8, a guiding unit includes an arcuate keyslot 225 formed in each tubular coupling member 22, and a key 75 extending from the end wall 72 of the corresponding actuating member 70 to be slidably engaged in the keyslot 225 so as to guide rotation of the corresponding actuating member 70.

Moreover, each of the rim positioning units 80 includes three recesses 81, 82, 83 which are formed in the rim 71 and which are angularly displaced from one another, and a spring-biased ball 84 which is disposed in the outer wall surface 223 of the respective tubular coupling member 22 and which is biased outwardly to be engaged in a selected one of the recesses 81, 82, 83 when the first and second toothed members 32 are in a corresponding one of the bi-directional, clockwise and counterclockwise positions.

With reference to FIGS. 3, 5 and 6, the releasing unit 40 includes a plurality of push rods 42 and a plurality of rod biasing members 43. Each of the push rods 42 is disposed in and movable relative to the internal chamber 61 along the wheel axis (L2), and has a first cammed region 422 that is in the form of a spring-biased ball 422 and that is matingly engaged with the first camming region 54, and a second camming region 421 that is matingly engaged with the second cammed region of the respective ball 63.

Each of the rod biasing members 43 is disposed between the driving head 60 and the first cammed region 422 to bias the respective push rod 42 toward the axial shaft 50.

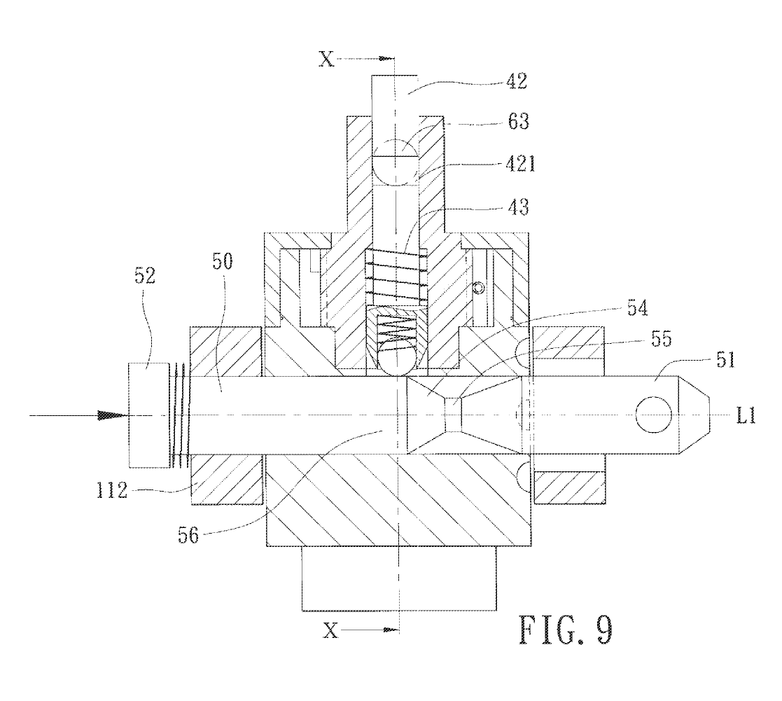

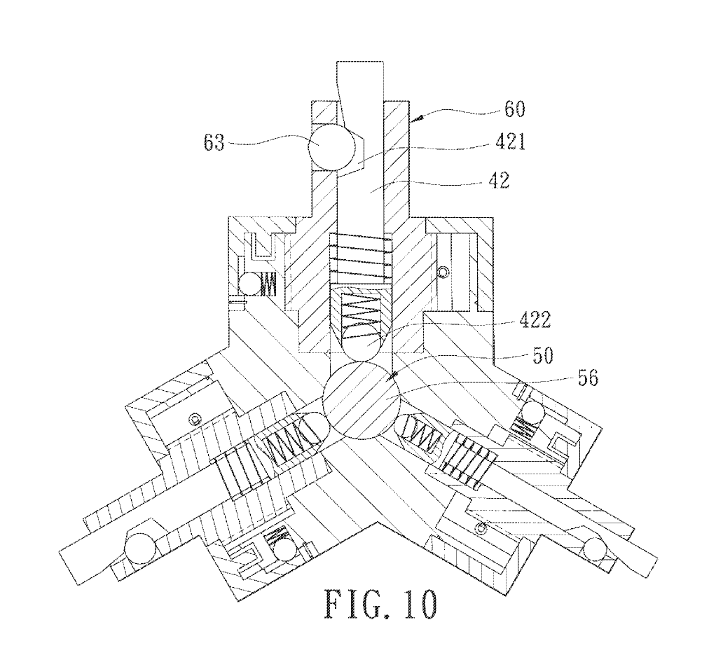

Accordingly, when the axial shaft 50 is in the non-actuating position, as shown in FIGS. 5 and 6, the first cammed region 422 is engaged with the smaller-diameter segment 55 so as to permit the ball 63 to extend outwardly of the through hole 62 for retaining a tool socket mounted on the driving head 60. As shown in FIGS. 9 and 10, when the axial shaft 50 is operated to move from the non-actuating position to the actuating position, the larger-diameter segment 56 is moved to be engaged with the first cammed region 422 such that the push rods 42 are moved along the wheel axis (L2) to permit the balls 63 to radially retreat in the internal chambers 61, thereby releasing the tool socket (s) mounted on the driving head(s) 60.

As illustrated, the ratchet wrench according to this invention has following advantages:

1. By rotating the head body 21 about the rotating axis (L1), the user can choose a desired one of the driving heads 60 with different configurations and dimensions, thereby rendering operation of the ratchet wrench convenient.

2. By rotating the respective actuating member 70 about the wheel axis (L2), the corresponding first and second toothed members 32 can be displaced to a desired one of the bi-directional position, the clockwise position, and the counterclockwise direction to permit selective rotation of the corresponding driving head 60 in a clockwise direction, a counterclockwise direction, or both of these without the need to remove the tool socket (that is engaged with the driving head 60) from a fastener.

3. By moving the axial shaft 50 along the rotating axis (L1) to the actuating position, the tool socket that is engaged with the driving head 60 can be removed easily for replacement.

While the present invention has been described in connection with what is considered the most practical and preferred embodiment, it is understood that this invention is not limited no the disclosed embodiment but is intended to cover various arrangements included within the spirit and scope of the broadest interpretations and equivalent arrangements.

What is claimed is:

1. A ratchet wrench comprising:
a handle having handgrip and head portions opposite to each other in a longitudinal direction, said head portion defining a rotating axis that extends transverse to the longitudinal direction;
a wrench head unit having a head body which is mounted on and rotatable relative to said head portion about the rotating axis, and a plurality of tubular coupling members which extend radially from said head body, and which are angularly displaced from each other about the rotating axis, each of said tubular coupling members having an inner wall surface which defines an accommodation space;
a plurality of ratchet units, each having
a ratchet wheel which is rotatably mounted in said accommodation space about a wheel axis radial to the rotating axis and which is spacedly surrounded by said inner wall surface,
first and second toothed members which are disposed between said ratchet wheel and said inner wall surface, and which have first and second outer surfaces slidably engaged with said inner wall surface, said first and second toothed members being configured to he displaceable among a bi-directional position, where said first and second toothed members are matingly engaged with said ratchet wheel to permit torque from a respective one of said coupling members to be transmitted to turn said ratchet wheel in both clockwise and counterclockwise directions about the wheel axis, a clockwise position, where said first toothed member is matingly engaged with said ratchet wheel while said second toothed member is disengaged from said ratchet wheel so as to permit the torque to be transmitted only to turn said ratchet wheel in the clockwise direction, and a counterclockwise position, where said second toothed member is matingly engaged with said ratchet wheel while said first toothed member is disengaged from said ratchet wheel so as to permit the torque to be transmitted only to turn said ratchet wheel in the counterclockwise direction, and
a biasing member which is disposed to bias said first and second toothed members toward the bi-directional position;
a plurality of driving heads, each extending along the wheel axis from said ratchet wheel and outwardly of said accommodation space, and adapted to be fittingly engaged in a tool socket; and
a plurality of actuating members, each having first and second actuating portions which are disposed in said accommodation space to selectively move said first and second toothed members away from the bi-directional position to a selected one of the clockwise and counterclockwise positions, and a manually operable portion which is disposed to be movable with said first and second actuating portions relative to a respective one of said tubular coupling members.

2. The ratchet wrench according to claim 1, wherein said inner wall surface of each of said tubular coupling members as forward and backward abutment regions spaced apart from each other in a circumferential direction, and configured such that, when said first and second toothed members are selectively biased by said biasing member to move from a corresponding one of the clockwise and counterclockwise positions to the bi-directional position, a corresponding one of said forward and backward abutment regions forces a corresponding one of said first and second toothed members radially against said ratchet wheel to ensure firmness of the mating engagement therebetween.

3. The ratchet wrench according to claim 2, wherein said first and second actuating portions are angularly spaced apart from each other, each of said tubular coupling members having an outer wall surface radially opposite to said inner wall surface, said manually operable portion being a rim which is disposed to surround, and be circumferentially movable relative to said outer wall surface.

4. The ratchet wrench according to claim 3, further comprising a plurality rim positioning units, each including three recesses which are formed in said rim and which are angularly displaced from one another, and a spring-biased ball which is disposed in said outer wall surface of a respective one of said tubular coupling members and which is biased outwardly to be engaged in a selected one of said recesses when said first and second toothed members are in a corresponding one of the bi-directional, clockwise and counterclockwise positions.

5. The ratchet wrench according to claim 1, wherein said ratchet wheel of each of said ratchet units defines an internal chamber which extends along said wheel axis and through a respective one of said driving heads, each of said driving heads having a through hole which extends radially to be communicated with said internal chamber;
said ratchet wrench further comprising:
an axial shaft which is mounted on said head portion, and which is configured to permit said head body to be rotatably supported thereon, said axial shaft having a first camming region and being disposed to be movable along the rotating axis between non-actuating and actuating positions;
a plurality of push rods, each of which is disposed in and movable relative to said internal chamber along the wheel axis, and having a first cammed region matingly engaged with said first camming region, and a second camming region such that movement of said axial shaft along the rotating axis results in movement of said second camming region along the wheel axis;
a plurality of balls, each of which is received in said through hole for retaining the tool socket, and has a second cammed region that is matingly engageable with said second camming portion such that, when said axial shaft is moved from the non-actuating position to the actuating position, said second camming region is brought to be matingly engaged with said second cammed region so as to permit said ball to radially retreat in said internal chamber, thereby releasing the tool socket; and
a plurality of rod biasing members, each of which is disposed to bias a respective one of said push rods toward said axial shaft.

6. The ratchet wrench according to claim 5, wherein said head portion of said handle includes first and second lugs spaced apart from each other to define a space for mounting said head body therein, said axial shaft extending through said first and second lugs, and having a retaining portion which is disposed to be frictionally engaged with said first lug, and an operating portion which extends outwardly of said second lug for manual operation.

7. The ratchet wrench according to claim 6, further comprising a shaft biasing member disposed between said operating portion and said second lug to bias said axial shaft to the non-actuating position.

8. The ratchet wrench according to claim 7, further comprising a head positioning unit including a plurality of concavities which are formed in said head body and which are angularly spaced apart from one another about the rotating axis, and a protrusion which is disposed on said first lug to be engaged with a click sound in selected one of said concavities so as to guard against rotation of said head body about the rotating axis.
